(19) United States
(12) Patent Application Publication
(10) Pub. No.: US 2010/0088002 A1
(43) Pub. Date: Apr. 8, 2010

(54) System for increasing fuel economy in vehicles

(76) Inventor: Gregory A. Welte, Frankfort, IN (US)

Correspondence Address: GREGORY A. WELTE, 806 NORTH COUNTY ROAD 700 WEST, FRANKFORT, IN, 46041, US

(21) Appl. No.: 12/287,237

(22) Filed: Oct. 7, 2008

(51) Int. Cl. G08G 1/09; G06F 19/00; G01C 21/00

(52) U.S. Cl. 701/99; 701/117

(57) ABSTRACT

A system for improving fuel economy of a motor vehicle, by reducing stops at traffic signals, to thereby attempt to keep the vehicle in continuous motion. The motor vehicle is equipped with a Global Position Sensor, GPS, and a computer. The GPS continually informs the computer of the current position of the vehicle. The computer is equipped with data-tables which enable it to identify (1) the next traffic signal which the vehicle will encounter and (2) the timing data for that traffic signal, which indicates when the signal will be green. The computer then computes a recommended speed for the vehicle, which speed will enable the vehicle to reach the traffic signal when the signal is green.

The invention increases gas mileage of a vehicle from low city-mileage to greater highway-mileage, by reducing stops at traffic signals, thereby maintaining the vehicle almost continually in motion.

The invention does this by synchronizing the vehicle's speed with traffic signals, so that the vehicle encounters more green lights, as opposed to red lights.

### BACKGROUND OF THE INVENTION

Driving a motor vehicle in a city consumes significantly more fuel than driving the vehicle a similar distance in the country.

One reason lies in the frequent stopping required at traffic signals in the city. Each stop wastes the kinetic energy (KE) which was previously accumulated by the vehicle. After the stop, the lost KE must be replaced. Thus, for every stop, the KE must be accumulated twice: once before the stop, and once afterward. This waste of KE is very large, as an example will illustrate.

Assume that a car obtains a fuel economy of 20 miles per gallon (MPG) in the city, and 28 MPG on the highway. If the car is not required to stop at traffic lights then, in effect, that car's driving becomes highway driving. Its fuel economy has effectively increased from 20 (city fuel economy) to 28 (highway fuel economy), for an increase of 40 percent (8/20).

Of course, this is a simplified, idealistic example. Nevertheless, the principle which it illustrates is clear.

Further, the actual increase can even exceed the estimate of 40 percent given above. The reason is that highway MPG for vehicles is computed at highway speeds, such as 55 mph. If a vehicle instead travels steadily at a lower speed such as 40 mph, then its actual fuel economy will be greater than the estimated highway fuel economy at 55 mph. One reason is that aerodynamic drag is a major retarding factor at such speeds. Aerodynamic drag is not only lower at the lower speed, but it is significantly lower because drag is non-linear with speed: the drag at 40 mph is less than ⅔ the drag at 60 mph.

Therefore, the invention, theoretically at least, can drastically improve fuel economy of motor vehicles.

Further, the invention may increase safety, because the peak speeds attained by vehicles will probably be reduced. That is, drivers will learn that nothing is gained by racing between traffic signals, only to stand and wait for a green light. Under the invention, drivers will be urged to cruise at moderate speeds between traffic signals, in order to encounter more green lights.

### OBJECTS OF THE INVENTION

An object of the invention is to provide a system which reduces stopping during vehicle trips.

Another object of the invention is to prompt drivers of vehicles to drive at a speed which causes the vehicle to reach traffic signals when the signals are green, to thereby eliminate the need to stop at the signals.

### SUMMARY OF THE INVENTION

A vehicle carries two devices: (1) a computer and (2) a GPS, Global Positioning System. The computer is equipped with knowledge of the (X, Y) coordinates of nearby traffic signals. The computer is also equipped with scheduling information for those traffic signals. The scheduling information indicates the precise time-of-day when each respective signal will turn green, and how long it will remain green.

During operation of the vehicle, the GPS continually determines the location of the moving vehicle in (X, Y) coordinates, and feeds the coordinates to the computer.

Thus, since the computer knows (1) the location of each traffic signal and (2) the continual location of the vehicle, the computer can continually determine the present distance between the vehicle and each upcoming traffic signal.

Based on that distance and the scheduling information, the computer continually computes a recommended speed which will cause the vehicle to reach the next traffic signal when the signal is green, thereby eliminating the need for the vehicle to stop at that upcoming signal.

### BRIEF DESCRIPTION OF THE DRAWINGS

FIGS. 1 and 2 illustrate distance-time plots superimposed on a vehicle approaching a traffic signal, and one form of the invention.

FIG. 3 illustrates a timing graph, which indicates times when traffic signal T100 shows green lights, to each of four vectors, or directions, V0, V90, V180, and V270.

FIG. 4 is a flow chart illustrating steps implemented by one form of the invention.

FIG. 5 illustrates a Road Identification Table, RIT. Each point (P1, P2, etc.) in the RIT of FIG. 5 is an (X, Y) coordinate, corresponding to a point P1, P2, etc. on a road in FIG. 7.

FIG. 6 illustrates a simplified road map.

FIG. 7 illustrates the road map of FIG. 6, but with points P1, P2, etc. marked thereon.

FIG. 8 illustrates computation of distances between a vehicle's actual position and various points on the map of FIG. 7. The smallest distance is taken as indicating the point closest to the vehicle.

FIG. 9 illustrates a Signal Ascertainment Table, SAT, which indicates, for a given position of a vehicle, and a given direction of travel, the next traffic signal which the vehicle will encounter.

FIG. 10 illustrates a Signal Distance Table, SDT, which indicates, for a given position of a vehicle, the distance to the next traffic signal.

FIG. 11 illustrates a Signal Timing Table, STT, which indicates the times-of-day, or equivalent, when the next traffic signal presents a green light to the vehicle.

### DETAILED DESCRIPTION OF THE INVENTION

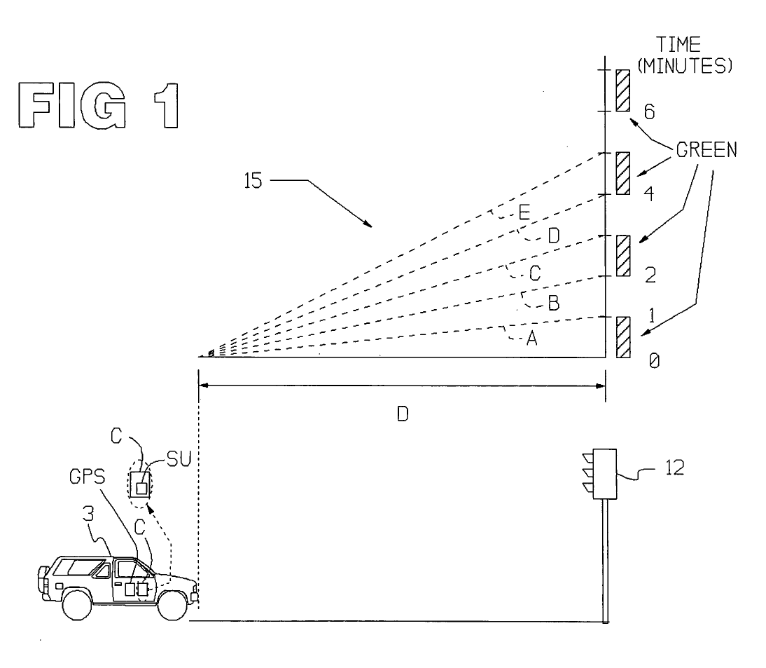

FIG. 1 illustrates a vehicle 3 which is approaching a traffic signal 12. A distance-time plot 15 is shown. Time, in minutes, is indicated on the vertical axis. The hatched blocks labeled GREEN indicate time intervals when the signal 12 displays a green light to the vehicle 3. For example, the signal 12 is green between the times of zero and one minute; the signal is also green between 2 and 3 minutes, and so on. FIG. 1 represents the location of the vehicle 3 at time zero, when the vehicle 3 is located a distance D from the signal 12.

The invention computes a speed for the vehicle 3 which will cause the vehicle 3 to reach the signal 12 when the signal 12 is green. The invention suggests this speed to the driver, as by speaking the suggested speed in a human voice, or displaying the suggested speed on a screen.

For example, if distance D is one mile, then if the vehicle 3 travels at a constant speed of just over 60 miles per hour, mph, vehicle 3 will nearly follow path A. Vehicle 3 will reach the signal 12 at the time of just under one minute, at which time the green light expires.

As another example, if the vehicle travels just under 30 mph, it will nearly follow path B, and reach the signal 12 just after the two-minute mark, just after the signal changed from red to green.

As a third example, if the vehicle travels just over 20 mph, it will nearly follow path C, and reach the signal just prior to the three-minute mark, just before the signal changes from green to red, and so on.

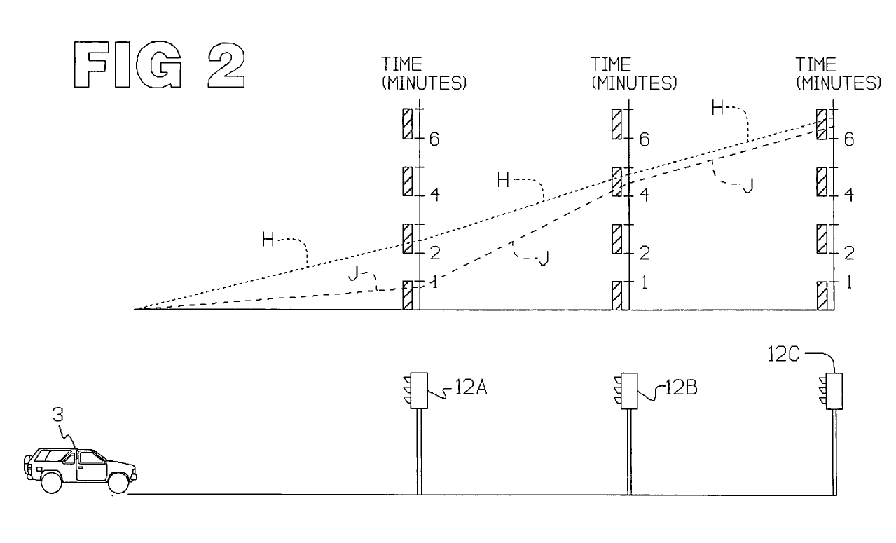

FIG. 2 illustrates three signals 12A, 12B, and 12C. The time plot above the signals indicates two possible speed-paths H and J which the invention can suggest. If the vehicle 3 follows either speed-path, it will encounter green lights at all three signals 12A, 12B, and 12C. The vehicle 3 need not stop at any of the signals 12A-12C.

The invention utilizes knowledge of the time-of-day at which the traffic signals display green lights. This knowledge can be (1) collected by human technicians who survey the traffic signals in advance, (2) obtained from the governmental agencies which operate the traffic signals, (3) obtained by the driver of the vehicle through examining stop lights or (4) obtained in other ways.

This knowledge may be stored in web sites on the Internet. The computer C in FIG. 1 can download this data from the web sites. The computer C can be equipped with a wireless connection, such as a wireless modem, to allow it to obtain this knowledge while installed in the vehicle.

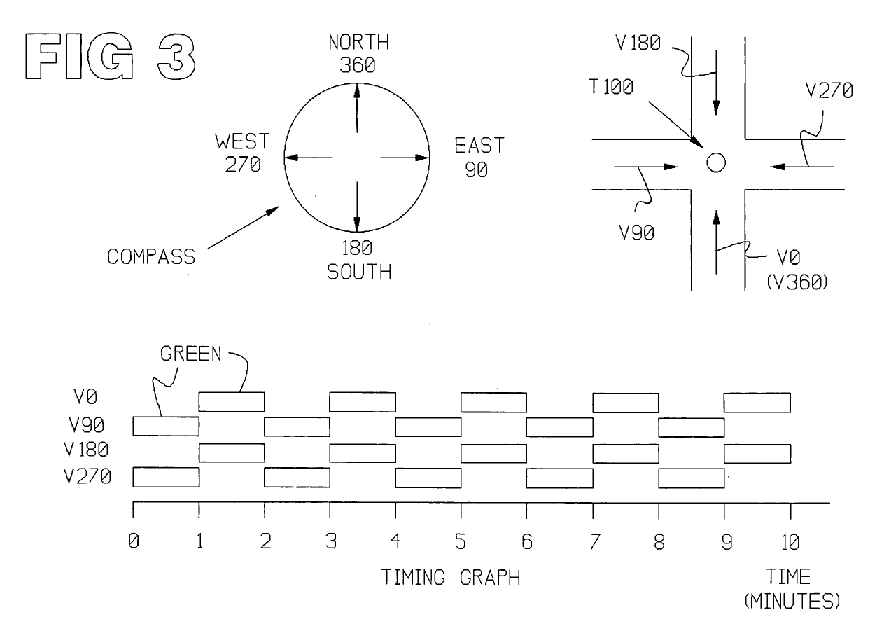

FIG. 3 provides a simple example of this information. A traffic signal T100, located at the intersection of two roads, controls traffic travelling in four directions, represented by vectors V0, V90, V180, and V270, which correspond to the compass directions of 0 (northbound), 90 (eastbound), 180 (southbound), and 270 (westbound) degrees, respectively. (By convention, vector V0 is the same as vector V360.) Diagram 23 indicates these compass directions.

Traffic signal T100 has a set of ordinary traffic lights (not shown) for each vector, for a total of four sets of traffic lights. Each set contains a green light, a yellow light, and a red light.

A TIMING GRAPH indicates when each set of lights is green. For example, according to the TIMING GRAPH, the set of lights controlling vector V0 is green for the period between 1 and 2 minutes. The set is also green for the period between 3 and 4 minutes, and so on. The set of lights controlling vector V90 is green for the period between 0 and 1 minutes, for the period between 2 and 3 minutes, and so on.

The TIMING GRAPH is illustrated in graphical form. In practice, it will probably be stored on the web sites in numerical form.

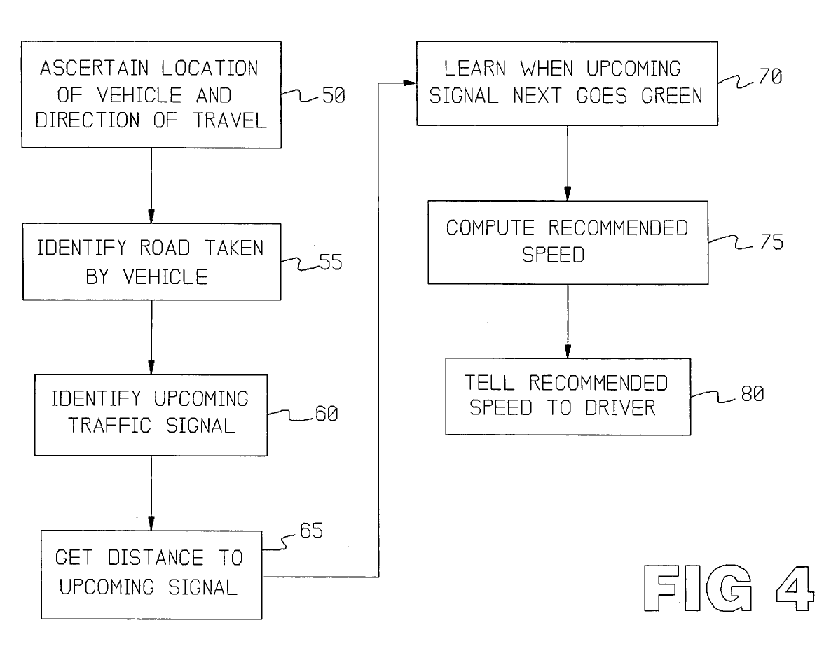

FIG. 4 is a flow chart illustrating steps implemented by one form of the invention. In block 50, the invention ascertains (1) the location of the vehicle 3, and (2) the direction of travel. This can be done using a Global Positioning System, GPS, contained within the vehicle, which is indicated in FIG. 1.

The GPS provides the latitude and longitude of the vehicle, which, for simplicity, will be referred to as (X, Y) coordinates herein. If the (X, Y) coordinates are found at two points in time, such as 5 seconds apart, then the coordinates taken at the later point can be taken as the position, and the coordinates of both points will indicate the direction of travel, or the current vector of the vehicle.

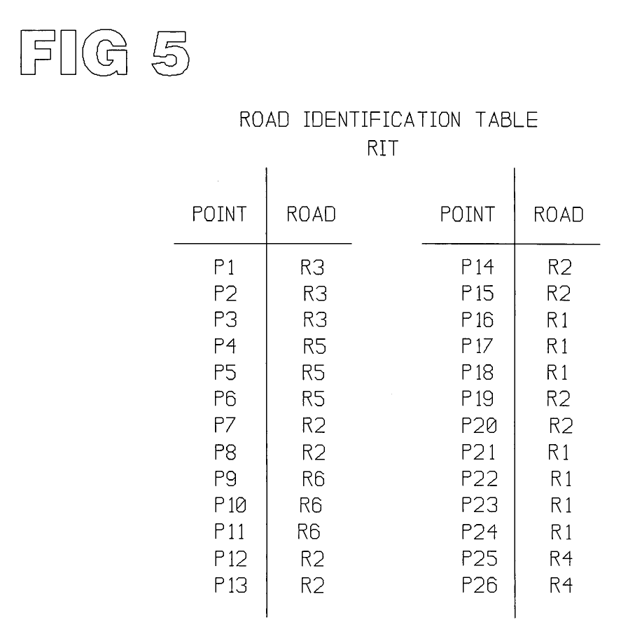

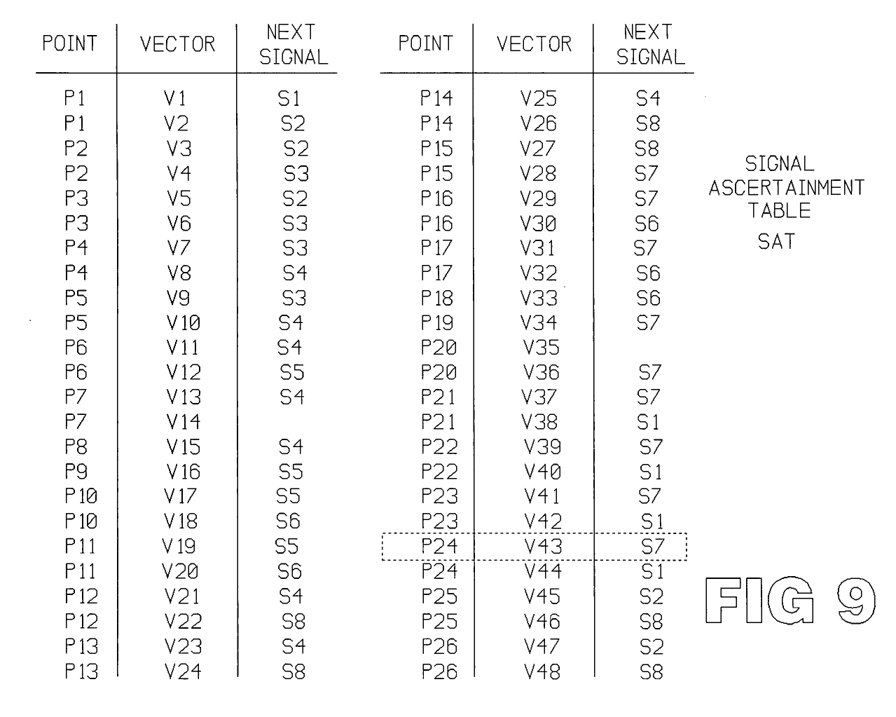

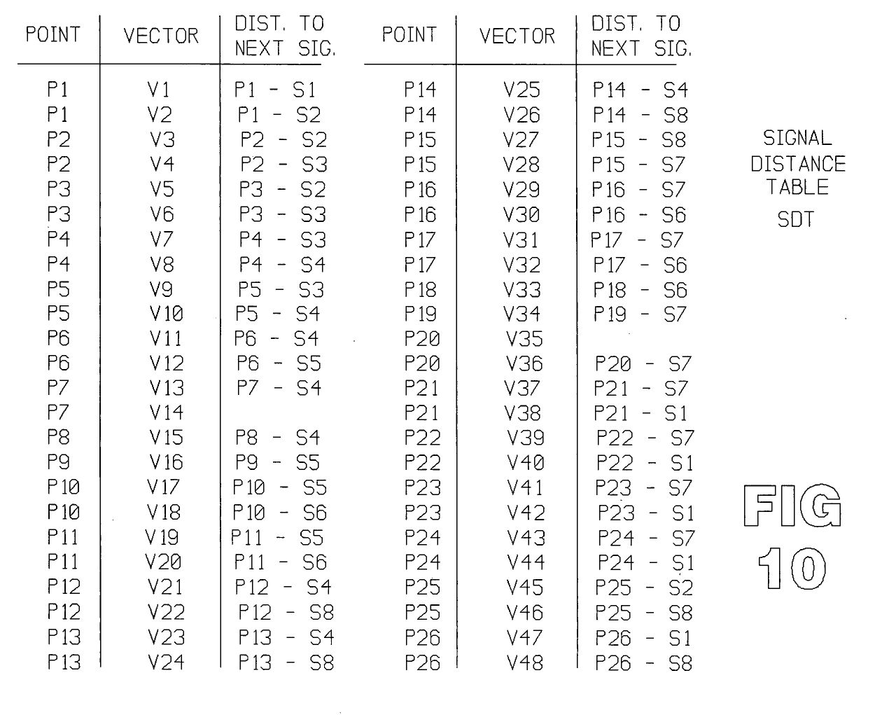

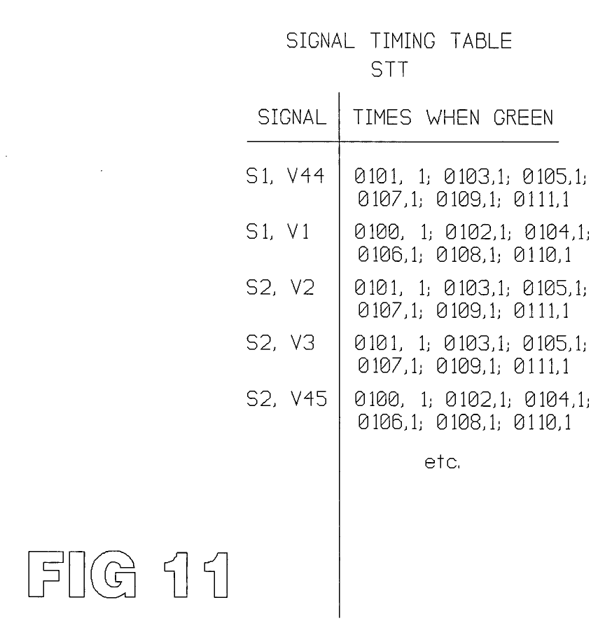

The invention then utilizes four data-tables, namely,
a Road Identification Table, RIT, (FIG. 5),
a Signal Ascertainment Table, SAT, (FIG. 9),
a Signal Distance Table, SDT, (FIG. 10), and
a Signal Timing Table, STT, (FIG. 11).
   These tables are prepared in advance. The use of these data-tables will now be described

In block 55 in FIG. 4, the invention ascertains the identity of the road on which the vehicle is traveling, based on one or more (X, Y) coordinates of the vehicle. Commercially available navigation software and systems are available for making this determination. Such software can run on the computer C in FIG. 1.

This determination may be made using the following principles.

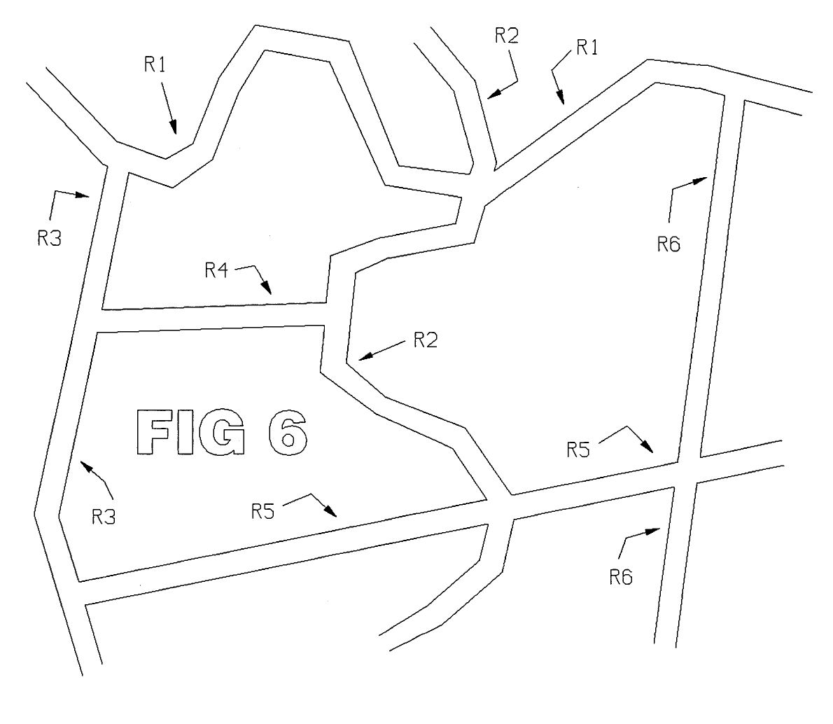

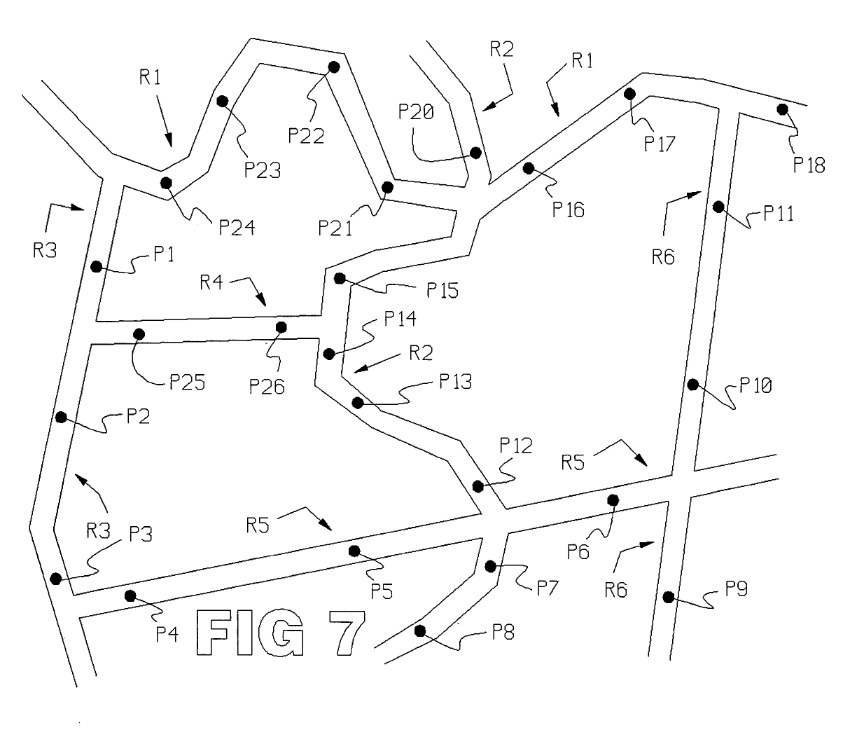

Prior to using the invention, a road identification table, RIT, is generated, such as that of FIG. 5, which corresponds to the road map of FIG. 6, which also appears in FIG. 7, which has points P1, P2, etc. marked thereon.

Each point (P1, P2, etc.) in the RIT of FIG. 5 is an (X, Y) coordinate, corresponding to a point P1, P2, etc. in FIG. 7. The RIT of FIG. 5 indicates the identity of the road on which each point is located. For example, the RIT indicates that road R3 contains point P3. Thus, the RIT allows the computer C in FIG. 1 to determine which road the vehicle 3 in FIG. 1 is located, based on one or more points at which the GPS determines that the vehicle is located.

Generation of the RIT of FIG. 5, based on the map of FIG. 7, is straightforward. The (X, Y) coordinates (ie, latitude and longitude) of each point on the map of FIG. 7 can be ascertained in the field, that is, at the physical location of the points on the actual roads, as by using a GPS, sextant, celestial navigation principles, or other navigation aid. Alternately, the coordinates can be ascertained in a laboratory using high-resolution navigation maps, which have latitude and longitude displayed on them.

The computer C in FIG. 1 uses the RIT by first consulting the GPS to determine which point P1-P26 in FIG. 7 the vehicle is nearest. This can be done in several ways. In one approach, the GPS in FIG. 1 continually reads the (X, Y) positions of the moving vehicle, and the computer C stores the most recent positions in memory, such as the last five positions. The computer continually consults the RIT to see if one of the stored points matches a point in the RIT.

In another approach, the computer stores the most recent (X, Y) position of the vehicle. The computer computes distances between that position and selected points in the RIT. The computer then selects the smallest of those distances. That smallest distance is taken to indicate the nearest point. That point is taken as the position of the vehicle, and the RIT allows a determination of the road on which the vehicle is driving, based on that point.

Thus, the RIT and the GPS allow the computer C to determine the road on which the vehicle is presently located.

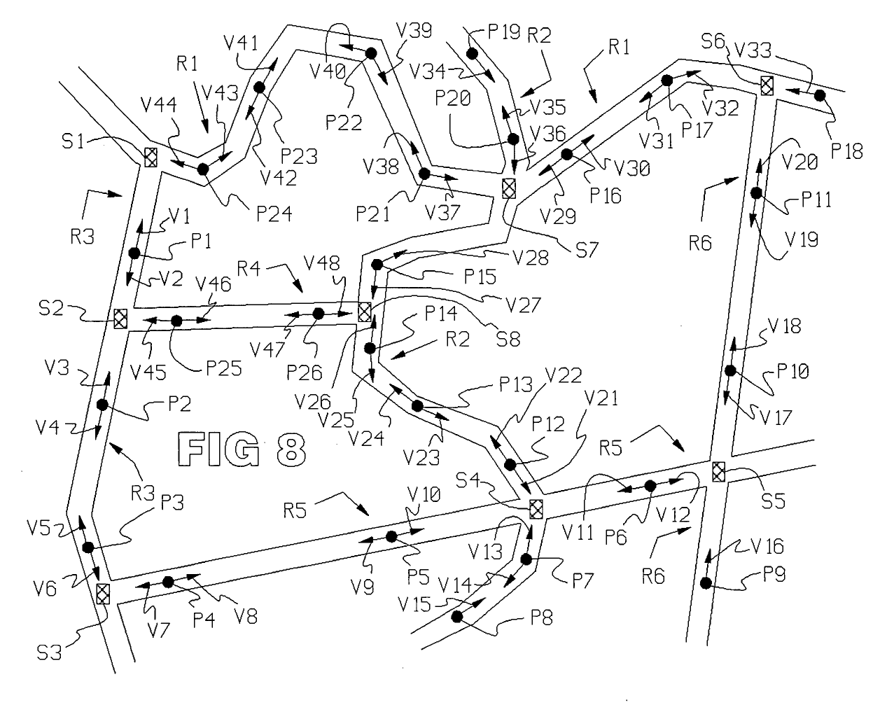

In addition, when the (X, Y) position of the vehicle is determined, a vector indicating the direction of travel is also determined. For example, if it is determined that the vehicle is located at point P7, at the bottom center of FIG. 7, then the computer C also determines whether the vehicle is heading in the direction of vector V13 or V14 in FIG. 8.

The purpose of the heading-vector will be explained shortly. The numbering of the vectors shown is arbitrary, and does not correspond to the compass vectors of FIG. 3. However, the vectors could be labeled consistently with the compass directions in which the vectors point.

In block 60 in FIG. 4, the invention then ascertains the next traffic signal which will be encountered, using a Signal Ascertainment Table, SAT, such as that shown in FIG. 9. One approach to using an SAT is the following.

Prior to using the invention, a technician marks the locations of traffic signals on the map, such as signals S1 through S8 in FIG. 8, which are located at intersections and represented by hatched boxes. The technician also draws the possible directions, or vectors, by which each signal can be approached, from the points on the map. For example, for point P24 (upper left quadrant of Figure), the vehicle can travel in the direction of vector V44, in which case the next signal to be reached will be signal S1. For point P24 the vehicle can also travel in the direction of vector V43, in which case the next signal will be S7.

Then, for each point-vector pair in FIG. 8, a determination is made of the next traffic signal corresponding to that pair. For example, if the vehicle is located at point P24 in FIG. 8, and travelling in the direction of vector V43, then it is known that the next traffic signal which will be encountered is signal S7. This fact is indicated on the SAT, as indicated by the dashed box in the right-hand column in FIG. 9.

This identification is repeated for all the points, to produce an SAT, Signal Ascertainment Table, of the type indicated in FIG. 9. This SAT allows the computer C in FIG. 1 to determine, for each point-and-vector pair, such as P24 and V43, the next traffic signal which will be encountered.

Next, in block 65 in FIG. 4, the invention utilizes the Signal Distance Table, SDT, to ascertain the current distance to the next traffic signal. A technician prepares the SDT by determining the distance from each point to the next traffic signal. FIG. 10 illustrates an SDT. The distances are indicated by phrases such as “P1-S1,” which means the distance between point P1 and signal S1 in FIG. 8. These distances are the actual distances travelled by a vehicle along the road, and are not direct, “as-the-crow-flies,” distances. To repeat: these distances are the distances which the vehicle must travel along the road, in order to reach the next signal, and are not another type of distance, such as a “great circle” distance.

Now that the computer C in FIG. 1 knows the distance to the next traffic signal, next, in block 70 in FIG. 4, the invention consults the Signal Timing Table, STT, to determine the times the upcoming signal will display a green light. FIG. 11 illustrates a simplified STT, and FIG. 3 illustrates an STT for a single traffic signal, in graphical form.

In FIG. 11, the first line, containing the entry “S1, V44,” indicates that the lights of signal S1 which control vehicles having vector V44 in FIG. 8 is green beginning at 0101 military time (which is 1:01 a.m.), and for a duration of one minute. This is written in shorthand notation of “0101, 1.” This line also indicates that this light is green beginning at 0103, for a duration of one minute, and so on.

The second line, containing the entry “S1, V1,” indicates that the lights of signal S1 which control vehicles having vector V1 in FIG. 8 is green beginning at 0100 military time (which is 1:00 a.m.), and for a duration of one minute. This is written in shorthand notation of “0100, 1.” This line also indicates that this light is green beginning at 0102, for a duration of one minute, and so on.

Of course, the content of the timing table, as with all other tables, can be written according to different formats or different shorthand notations.

Based on (1) the current distance to the upcoming signal, (2) the timing data specified in the STT, and (3) the current time-of-day (which is known to the computer C), the invention computes a recommended speed for the vehicle, so that the vehicle will arrive at the signal when the signal displays a green light. Block 75 in FIG. 4 indicates the computation. In block 80, the recommended speed is told to the driver.

One summary of the preceding is this: First, the invention ascertains the (X, Y) coordinates of the vehicle 3 in FIG. 1. Next, the invention ascertains the identity of the next traffic signal which the vehicle will encounter. Next, the invention ascertains the time(s) when that signal will display a green light. Next, the invention computes the time interval(s) between the present time and the onsets of those green lights.

Next, the invention computes the current distance to that next signal. Then, based on the computed time interval(s) and the current distance, the invention computes a recommended speed which will cause the vehicle to reach the signal while the signal is green.

An invention has been described in which a motor vehicle is equipped with a Global Position Sensor, GPS, and a computer. The GPS continually informs the computer of the current position of the vehicle. The computer is equipped with data-tables which enable it to identify (1) the next traffic signal which the vehicle will encounter and (2) the timing data for that traffic signal. The computer then computes a recommended speed for the vehicle, which speed will enable the vehicle to reach the traffic signal when the signal is green.

### Additional Considerations

1. Sometimes, such as late at night, on main roads, the traffic signals are set to display green lights to vehicles on the main road, and red lights to vehicles on roads crossing the main road. Then, sensors on the crossing roads detect the arrival of a vehicle on a crossing road. The sensors trigger the signal to change to green, to allow the arriving vehicle to enter the main road.

This situation may alter the timing data of the STT, because the change of the signal caused by the arrival of the vehicle may be random in time.

If this causes a problem, the problem can be eliminated if the traffic signal which changed to green is required to do so in synchrony with the ordinary timing schedule. For example, assume that the ordinary timing schedule is that for vector V0 in FIG. 3. If, when the timing schedule is suspended, as occurs late at night as discussed above, when a vehicle arrives at time 2.5 minutes, when the light is red, then the light does not change immediately. Instead, the system is required to wait until time 3.0 minutes, when it changes the light to green. The light remains green until time 4.0 minutes.

In this manner, the ordinary timing of the lights is not disturbed. Of course, this may require a driver approaching on a cross-road to wait a few extra seconds, until the time arrives for a scheduled green light.

This approach can be explained from another perspective. The traffic signals on the main road follow a schedule such as that in FIG. 3. However, late at night, the schedule is suspended, and the signals display green lights to the traffic on the main road.

If a car driving on a crossing road arrives at a signal (which is red for that car), a sensor detects the arrival of the car. The sensor triggers the signal to resume its scheduled operation, but for one change of red-green-red only. Then the signal remains green for traffic on the main road, as before.

To repeat again: the ordinary schedule is suspended late at night, when all lights on the main road are caused to be green. However, if a vehicle arrives at a road which crosses the main road, the schedule is called into action for one red-green-red cycle, to allow the vehicle to enter the main road. Then the ordinary schedule is suspended again.

2. A range of recommended speeds for the driver is possible. For example, in FIG. 1, if the vehicle 3 arrives at the signal 12 at any time between zero and 1 minute, vehicle 3 will encounter a green light. Those times represent a range of speeds.

3. It is not necessarily required that vectors, such as vectors V1-V44 in FIG. 8, be computed. Some contrasting cases will be explained.

A vector may be used. If the vehicle is located at point P1 in FIG. 8 (upper left quadrant), then knowing that the vehicle is following vector V1 indicates that the vehicle is proceeding toward signal S1. In this example, a vector is used.

However, other approaches are possible. In one method, the sequence of points crossed by the vehicle is stored in memory. That sequence will indicate which signal is being approached. For instance, the sequence P3, P2, then P1 in FIG. 8 indicates that, when the vehicle is at point P1, signal S1 is being approached, because the vehicle has already crossed points P3 and P2. The crossing of the latter two points (P2 and P3) is inconsistent with an approach to signal S3, for example.

In another method, the identity of the last traffic signal encountered is stored. That information allows the computer C to deduce the next signal to be encountered by elimination. For instance, if the vehicle is at point P1 in FIG. 8, and it is known that signal S2 has already been encountered, then it is known that the next signal to be encountered is signal S1. Of course, if the vehicle makes a U-turn, this method must be modified.

4. Once the distance to the next upcoming traffic signal is determined, the invention computes a recommended speed for the vehicle so that the vehicle will reach that next signal when it is green for the vehicle.

This computation can be done using the STT as in FIG. 11, for the signal identified as the next to be encountered. One or more recommended speeds can be computed, as indicated in FIGS. 1 and 2. The timing graphs for the traffic signals can be provided by the local governmental agencies which operate the traffic signals.

The recommended speeds are communicated to the driver of the vehicle by printing on the display screen (not shown) of the computer C of FIG. 1, or by conversion to speech, using a speech synthesis unit SU. The latter does not require that the driver remove his eyes from the road.

Alternately, the computer C can continually compute the amount of time left for the current signal displayed by the upcoming traffic signal, as in a countdown, as by speaking “10 seconds left on current green . . . 9 seconds left on current green . . . 8 seconds left on current green” and so on.

5. Each traffic signal can be assigned a unique identifier, such as its (X, Y) coordinates. The timing graph for the signals can be stored on web sites made available to the public. The computer C in FIG. 1 downloads the relevant timing graphs of FIGS. 3 and 11 from the web sites.

Different governmental agencies will control different traffic signals, and thus a given person will probably be required to visit two or more web sites to obtain all needed timing graphs for a given trip. However, since each traffic signal is assigned a unique identifier, this is seen as posing no problem.

Nevertheless, since the overall amount of data involved for all traffic signals in the United States is small, compared to the storage capacity of modern computers, it is possible that the federal government, or a private entity, may wish to store the data for all traffic signals in a single web site. Perhaps a fee can be levied to users of the web site, to cover the government's costs.

6. In FIG. 1, at precisely the two-minute mark, when the signal 12 changes from red to green, it is likely that a queue of vehicles will be present at the signal 12, awaiting the green light. Thus, it is perhaps not desirable that the vehicle 3 be scheduled to arrive at the signal 12 at that moment, because it will encounter the queue. Instead, the invention can compute a speed which will cause the vehicle 3 to arrive at time such as 15 seconds after the light changes to green. The time of 15 seconds is taken as representative of the time required for the queue to clear the intersection. Other times can be used.

7. Not all the steps outlined above are necessarily required. An elaborate number of steps was given, for completeness of explanation. However, the goal is to recommend a speed to the driver of a vehicle which will cause the vehicle to reach the next traffic signal when the signal is green. This goal can be attained without executing all steps discussed above. For example, the next traffic signal to be encountered can be determined by learning the location and vector of the vehicle. Alternately, this determination can be made based on the sequence of traffic signals previously encountered. That is, if the known sequence of signals is ABCDE, and if the vehicle has encountered ABC, then it is known that the next signal will be D.

8. The word “green” was used above. A traffic signal which displays a green light to a vehicle is telling the vehicle that the vehicle has the right to proceed past the traffic signal. Of course, the traffic signal can convey this information in equivalent ways. For example, a railroad crossing signal may lower a gate which blocks vehicles. That is equivalent to a “red” signal. When the gate is raised, that is equivalent to a “green” signal.

9. The current time-of-day is used, for example, to compute the time interval between the present instant and the future time at which the signal changes to green, which is indicated in the STT of FIG. 11. That is, the current time-of-day, and the STT, indicates the time interval over which the vehicle must travel the distance to the next signal.

For example, assume that the STT indicates to the computer C that the signal is currently green, and will remain green for 30 more seconds. Assume that the SDT indicates that the distance to that signal is ½ mile. Thus, it is known that the vehicle should cover that ½ mile distance in 30 seconds or fewer. Covering a distance of ½ mile in 30 seconds corresponds to a vehicle speed of 60 mph. If the vehicle travels at 60 mph or faster, it will reach the signal while the signal remains green, provided that it does not travel too fast to reach a red light.

The STT also indicates the timing for the next green signal after the current green signal expires, for a given signal. For example, assume that the STT indicates that (1) the current green signal expires in 30 seconds, (2) a red signal will be displayed for the next 30 seconds, and then (3) a green signal is again displayed for 30 seconds. Thus, the next green signal will begin in 60 seconds, and expire in 90 seconds.

If the vehicle is ½ mile away, as above, then it should cover that ½ mile in a time interval lying between 60 and 90 seconds.

10. The discussion above assumed that various items of information were obtained from web sites, which may be maintained by government agencies. In another form of the invention, each traffic signal is equipped with a radio transmitter and a small computer system which broadcasts the timing data.

In addition, each traffic signal will broadcast an ID code which identifies itself. The ID code is associated with the timing data, so that, if a vehicle receives data from more than one traffic signal, because the signals are close together, the vehicle can isolate the data which is relevant to it.

For example, assume that the vehicle is located at point P25 (left of center) in FIG. 7, and is travelling toward traffic signal S2. This vehicle could receive data from traffic signals S1, S2, S3, and S8, as well as others.

Assume that each traffic signal broadcasts data in the following format: (Signal ID, vector, timing data for next five minutes), wherein
Signal ID identifies the traffic signal,
Vector identifies the vector to which the data packet applies, and
Timing Data indicates the time-of-day, or equivalent, when the light will be green for the Vector, over the next five minutes.
   Under this assumption, the vehicle simply extracts the data packet from the incoming data which corresponds to (1) signal S2 and (2) vector V45, and uses the timing data.

It is recognized that the vehicle will receive multiple data packets from each traffic signal, and also data packets from multiple traffic signals. Numerous communication protocols can be used to handle the situation, such as (1) assigning each traffic signal specific windows in time for transmitting, (2) assigning each traffic signal different frequencies, and so on. The problem is no different in principle than assigning each traffic signal a cell phone number.

11. In one form of the invention, each traffic is assigned a unique communication channel, such as a cell phone number, or a specific set of windows in time for transmitting, or a specific frequency for transmitting. It uses that channel to transmit its timing data for each vector it controls.

12. The Global Positioning System transmits time-of-day information. This information can be used by all parties for synchronization. For example, the government agency which operates the traffic signals must know the exact time of day at which the signals are programmed to be green. The computer in the vehicle must know the current time of day, in order to compute the time interval between the present time and the time when an upcoming light turns green. If the computer and the agency both use the GPS's time signals, then they will be in synchrony.

13. One form of the invention is specifically directed to motor vehicles which use the public roadways, and encounters red-green traffic signals on those roadways. This form of the invention is not applicable to vehicles generally, such as railroad cars, ships, or aircraft.

Numerous substitutions and modifications can be undertaken without departing from the true spirit and scope of the invention. What is desired to be secured by Letters Patent is the invention as defined in the following claims.

1. Apparatus used by a vehicle which approaches traffic signals, comprising:
a) a Global Positioning System, GPS, within the vehicle, which ascertains (X, Y) coordinates of the vehicle;
b) a computer within the vehicle which
i) uses the (X, Y) coordinates to identify a traffic signal which the vehicle will encounter next,
ii) locates timing data which indicates times when the identified traffic signal will display a green light to the vehicle,
iii) determines distance between the vehicle and the identified signal,
iv) computes a recommended speed, based on the distance and the timing data, which will cause the vehicle to reach the identified signal when the signal displays a green light to the vehicle, and
v) communicates the recommended speed to a person in the vehicle.

2. Apparatus used by a vehicle which is approaching a traffic signal, comprising:
a) a Global Positioning System, GPS, within the vehicle, which ascertains (X, Y) coordinates of the vehicle; and
b) a computer within the vehicle which uses the (X, Y) coordinates to compute a speed which will cause the vehicle to reach the traffic signal when the traffic signal displays green to the vehicle.
